(19) United States
(12) Patent Application Publication
(10) Pub. No.: US 2009/0213918 A1
(43) Pub. Date: Aug. 27, 2009

(54) SEPARATING JITTER COMPONENTS IN A DATA STREAM

(76) Inventor: Thomas E. Waschura, Menlo Park, CA (US)

Correspondence Address: PENINSULA IP GROUP, 26150 BUCKS RUN, CORRAL DE TIERRA, CA, 93908, US

(21) Appl. No.: 12/038,165

(22) Filed: Feb. 27, 2008

(51) Int. Cl. H04B 17/00; G06F 11/00

(52) U.S. Cl. 375/226; 714/704; 714/E11.004

(57) ABSTRACT

A method and corresponding device for measuring jitter in a data stream and separating the jitter into its various components is disclosed. The measurement device includes a sampling circuit operative to provide a sampled version of an input data stream in response to a sampling control signal; a comparison circuit operative to provide a signal representing the difference between the sampled input data and a reference pattern; an error counter circuit operative to maintain the number of times the sampled input data does not match the reference pattern or a bit selection value within a bit window; and a bit selector circuit operative to provide the bit selection value in response to the bit sampling window of the circuit.

### BACKGROUND OF THE INVENTION

1. Field of the Invention

The present invention relates generally to communication systems. More particularly, the present invention relates to detecting and separating jitter from data streams propagating along a communication system network using threshold-detected decision circuits.

2. Description of the Related Art

Jitter is the time displacement of bit transitions in a data stream from their ideal positions. Understanding and being able to identify and separate the various jitter components within a data stream has become of significant importance given the ever-increasing throughput rates in communication systems, as well as densely storing larger amount of data within a particular size of memory. Jitter, for example, total jitter, random jitter, deterministic jitter, periodic jitter, periodic sub-rate jitter, data deterministic jitter, inter-symbol jitter, emphasis jitter and duty-cycle jitter may cause mis-interpretation of data bits which, in turn, leads to bit errors which may significantly limit the operation of an underlying communication channel. Individual components of jitter are typically introduced within a communication channel, for example, by low pass filtering effects of the communication medium, by noise effects present in semi-conductors, by interference from nearby signal sources or by other physical that affects the operation of the communication channel or system.

Conventional methods of separating jitter into components centered on time interval analyzers. These type of analyzers were limited in that they only detected deterministic jitter within a data stream or communication system; however, even this relatively simple separation was useful to gain an understanding of a communication system's performance. Time interval analyzers would study the precise time between two edges. This data was used to create probability density functions, which were then analyzed. Effective edge time interval sampling rates for these devices were less than one megahertz sample per second, while data rates were operating at speeds that exceeded one giga bit per second. This drove a great need to precisely fit mathematical functions to the sparsely sampled tails of probability distributions because the distributions were practically too shallow for traditional curve-fitting techniques.

Other conventional methods used to separate jitter into various components include the use of digital deep-memory oscilloscopes. To the depths of a single-capture method (e.g. upwards of 64 Msamples), a waveform could be captured that included data bit representations (e.g. often seven analog-to-digital waveform samples per data bit). In this manner, a digital representation of 10 Msamples could be analyzed. By an analyzing this data, probability density functions could be extracted and used to similarly separate jitter into various components. Initial efforts duplicated the random jitter versus deterministic jitter separation techniques and then were extended to include other jitter separation. A drawback associated with this type of techniques is that it takes a significant amount of processing time and is limited to jitter components that would occur within a 10 Mbit window. Additionally, the precise time of each sample in this technique was asynchronous to the data rate of the communications such that interpolations between sample points were needed to find the voltage at the particular instant of interested (at the jitter crossing). This introduced additional error in the measurement.

What is needed is a method of separating jitter into all of its component easily and efficiently.

### SUMMARY OF THE INVENTION

In an exemplary embodiment, a jitter measurement and separation circuit according to the present invention includes a sampling circuit that provides a sampled version of an input data stream in response to a sampling control signal. In the exemplary embodiment, the sampling control signal may be programmed, or otherwise adjusted, to ensure sampling at certain time offsets within the bit period of the input data stream. The circuit also includes a comparison circuit that provides a signal representing the difference between the sampled input data and a reference pattern. Depending on the type of jitter being detected, the differences may be detected throughout the entire input data stream, or only a particular bit within the input data stream. An error counter circuit is coupled to the comparison circuit, and maintains the number of times the sampled input data does not match the reference pattern or a bit selection value within a bit window. Finally, a bit selector circuit provides the bit selection value in response to the bit sampling window of the circuit. As such, if a bit selection value is provided, differences between the sampled data stream and the particular bit represented by the bit selection value are compared. Such a measurement would be useful, for example, in determining the amount of deterministic jitter present within a data stream or a larger communications channel.

A jitter measurement and separation method includes the steps of first sampling an input data stream. Next, the amount of random jitter present within the input data stream is determined. Then, the amount of deterministic jitter present within the input data stream is determined. The total amount of jitter present within an input data stream is equal to the sum of the random jitter and the deterministic jitter present within the data stream.

An advantage provided by the present invention is that it performs complex, accurate and high-bandwidth jitter separation with higher effective sample rates which allows for jitter separation in longer patterns and additional jitter classifications.

Another advantage provided by the present invention is that bit error rate based measurements are used to perform jitter separation which allows for deep, convenient, multi-function capabilities to optimize manufacturing test instrument investment while not losing measurement quality.

Yet another advantage provided by the present invention is that jitter separation rates of about 250,000 times faster than conventional separation methodologies may be achieved.

### BRIEF DESCRIPTION OF THE DRAWING

The aforementioned and related advantages and features of the present invention will be best appreciated and understood upon review of the following detailed description of the invention, taken in conjunction with the following drawings, where like numerals represent like elements, in which:

FIG. 1 is a block diagram illustrating the hierarchy of jitter sub-components that comprise the total jitter present in a communication system;

FIG. 2 is a schematic block diagram of a jitter measurement and separation circuit configured to perform the jitter detection and separation functionality of the present invention;

FIG. 3 is a flow chart illustrating the steps performed by the jitter measurement and separation circuit when determining the several components of jitter transmitted along a communication system; and

FIGS. 4A-4D are diagrams illustrating how bit error rate measurements may be used to identify average jitter transition time.

### DETAILED DESCRIPTION OF THE INVENTION

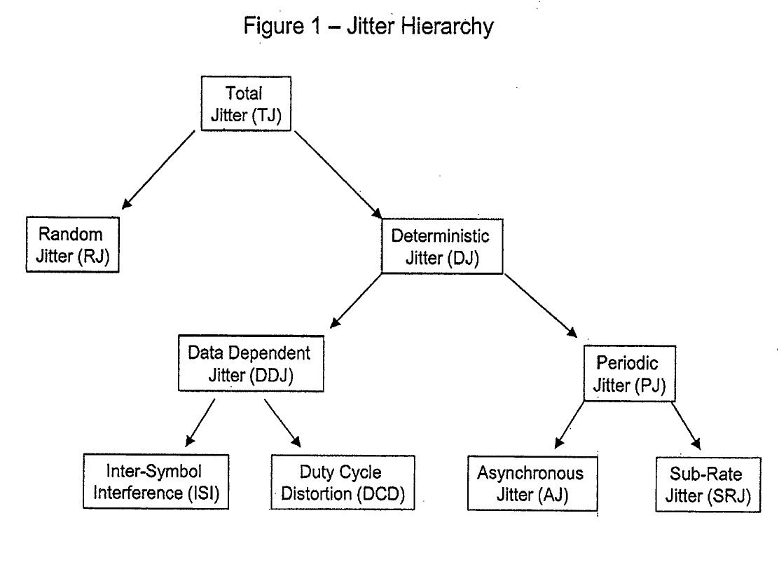

An exemplary embodiment of the present invention will now be described with reference to FIGS. 1-4D. Although a preferred embodiment is illustrated and described, the present may be embodied in many different forms and should not be construed as limited to the embodiments set forth herein. Rather, these embodiments are provided so that this disclosure will be thorough and complete and will fully convey the invention to those or ordinary skill in the art.

Jitter is the time displacement of bit transitions in a data stream from their ideal time position. Separating jitter into its various components may be done by first separating the total jitter (TJ) within a data stream into random and deterministic components. In random jitter, the bit transition time instants randomly distribute themselves about a mean time instant with some bell-shaped (e.g. Gaussian) distribution. Deterministic jitter (DJ) is not random. It is comprised of jitter related to the data pattern propagating along a communication system. Data-dependent jitter (DDJ) and as well as other forms of jitter that are not related to the data pattern are referred to as Periodic Jitter (PJ). Data-dependent jitter (DDJ) may further be broken down into emphasis jitter (EJ), duty cycle distortion (DCD) jitter and jitter caused by the time instant displacements of individual bits of the data pattern, referred to as inter-symbol interference (ISI) jitter. Jitter that is periodic and has a frequency that is not the same as the data pattern repetition frequency being used in the measurement is classified as being Periodic Jitter (PJ). Periodic Sub-Rate Jitter (SRJ) and jitter having a period that is asynchronous to the frequency of the data pattern propagating along a communication system is referred to as Asynchronous Jitter (AJ).

Bit error rate (BER) testers are uniquely positioned to make highly accurate and deep measurements in the domain of serial communications. Depth of bit error rate measurement stems from high-speed counters that count the result of each programmable threshold bit comparison at the full data-rate. In modern communications systems, rather than 40 KHz-10 MHz sampling rates of traditional measuring equipment, 10 GHz count information can be accumulated and used to make jitter separation measurements.

FIG. 1 is a block diagram illustrating the hierarchy of jitter sub-components that comprise the total jitter present in a communication channel or system. As illustrated, the total jitter (TJ) 10 is equal to the sum of the random jitter (RJ) 12 within a data stream and the deterministic jitter (DJ) 14 within the data stream. Random jitter 12 does not have a direct relationship with the actual data stream. Instead, the bit transition time instants randomly distribute themselves about a mean time instant with some bell-shaped distribution. The standard deviation of the bell-shape is the root mean square random jitter. Gaussian (e.g. bell-curve) distribution tails extend to infinity in both directions; thus, it is typical to define the peak-to-peak random jitter to a point on the Gaussian distribution that corresponds to encompassing some percentage of the entire distribution. This is typically referred to as a particular bit error rate or confidence level. Using the properties of Gaussian distributions, the peak-to-peak jitter value is most-often computed as approximately 14 times the root mean square jitter which expresses the peak-to-peak value down to a bit error rate of 1×10E-12.

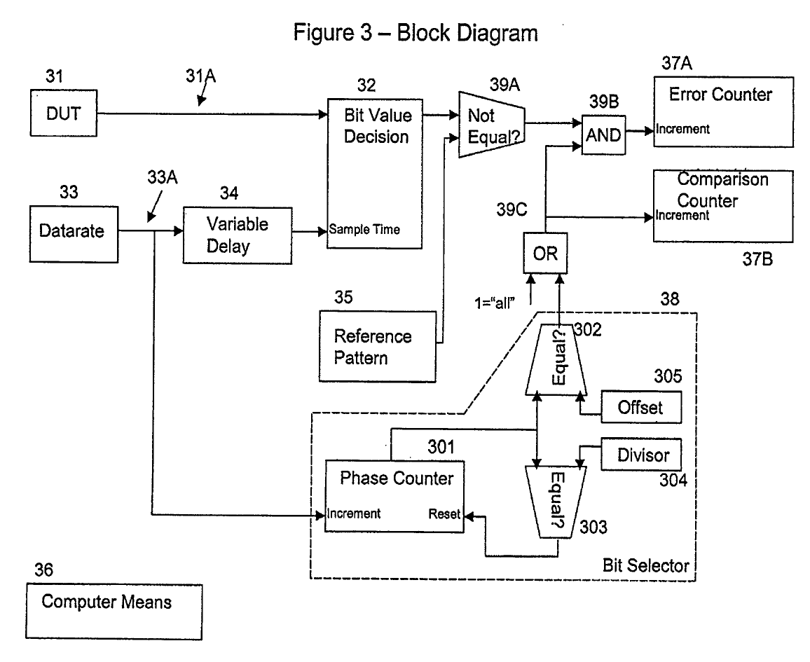

Deterministic jitter 14 is not random, but rather is related to some form of repetitive jitter present in the communication channel. Deterministic jitter 14 is comprised as the sum of data dependent jitter (DDJ) 16 within a data stream and periodic jitter (PJ) 17 within the data stream. Data dependent jitter 16 can be considered to be the sum of three types of jitter sub-components: Emphasis Jitter (EJ) 18, Inter-Symbol Interference (ISI) jitter 22 and Duty Cycle Distortion (DCD) jitter 20. The determination of the sub-component values will be described in greater detail with reference to FIG. 3. Data dependent jitter 16 may be calculated, for example, by individually looking at each bit of the input data stream and for each bit determining the average transition time by varying the decision time about one or more transition points. Stated differently, data dependent jitter may be calculated by subtracting the earliest transition from the latest transition within the input data stream.

Periodic Jitter (PJ) 17 may be considered the sum of Asynchronous Jitter (AJ) 19 and Sub-Rate Jitter (SRJ) 21. Sub-rate jitter 21 may be determined, at least in part, by stepping through all sub-rates (e.g. individual frequencies or bits) of interest and at each sub-rate computing the peak-to-peak deviation of average transition times for all phases of a sub-rate divider. The periodic jitter 17 is comprised of all distortions present in deterministic jitter that is not data dependent. Asynchronous jitter 19 is then determined to be the difference between periodic jitter and sub-rate jitter. The present invention samples an input data stream and separates the aforementioned types of information from the input data stream; thereby, providing a means for determining the stability and accuracy of information being transmitted through a communication system.

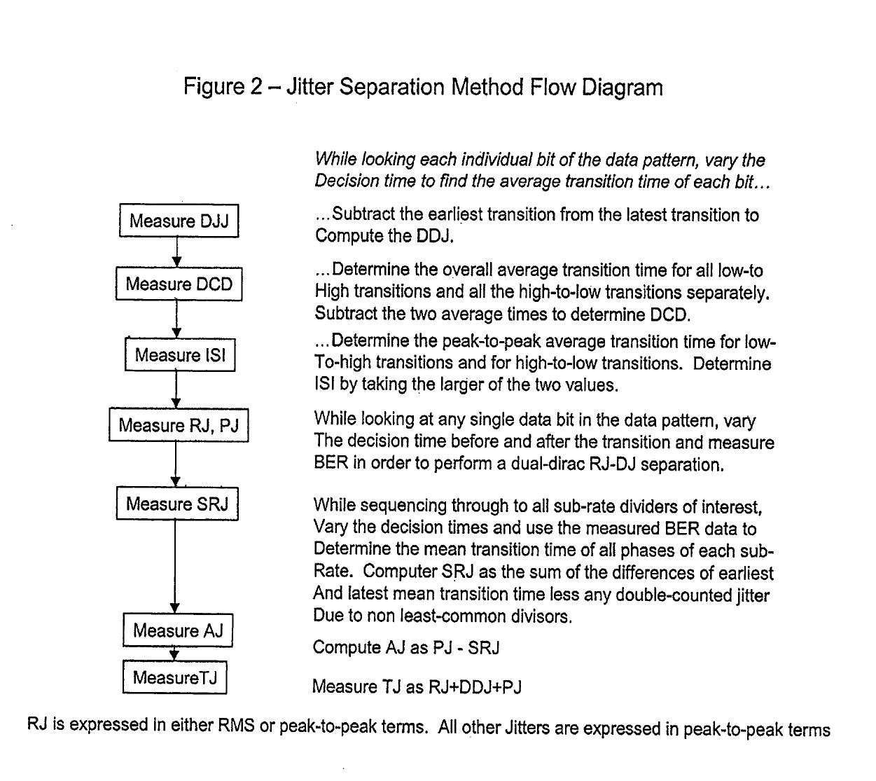

FIG. 2 is a schematic block diagram of a jitter measurement and separation circuit of the present invention. The separation circuit 100 may be implemented as a stand-alone device, as a component within a larger bit error rate tester, or other suitable device and combinations thereof. A device under test (DUT) 31, for example, a transmitter, and/or a transmission medium of a communication system provides or has propagating thereon an input data stream 131, comprised of a signal having one or more signal transitions between a logic low (e.g. a zero) and a logic high (e.g. a one). The data stream 131 has a data rate of a given frequency and a pattern length (as measured in bits). The total amount of jitter present within the input data stream 131 depends on the type of device or component that provides the input data stream 131.

The output of the device under test 31, the input data stream 131, is provided as an input to a sampling circuit 32, for example, a D type flip-flop. The sampling circuit 32 provides a sampled version of the input data stream 132 at its output in response to a programmable sampling control signal 134. The clock (CLK) input of the sampling circuit 32 is coupled to the sampling control signal 134 that controls the initiation of the sampling performed by the sampling circuit 32. This may occur, for example, during the time periods between rising edges, falling edges or both edges of a sampling clock signal, or at the bits corresponding to the transition between rising edges and/or falling edges.

A clock generator 33, for example, a crystal oscillator or other suitable device generates a sample clock signal 133 that is provided to a variable delay circuit 34 as well as the increment input of a phase counter 301. The variable delay circuit 34 may be implemented by any suitable circuit operative to provide a programmable amount of delay to the sample clock signal 133; thereby, providing the ability for the sampling circuit 32 to sample the input data stream 31 at any time instant within a bit of the input data stream 31 at the full-bit rate speed of the device under test 31. In an alternate embodiment, the variable delay circuit 34 may be implemented as an elongated trace on a corresponding board or other suitable device.

The sampled input data stream 132 is provided as a first input to a comparator 30. The second input to the comparator 39 is coupled to a reference data pattern 135 that is provided by a reference pattern generator 35. The comparator 39 compares the bits of the input data stream 132 with the corresponding bits of the reference data pattern 135 and determines if there are any differences or mismatches between the two data streams, and provides a mismatch signal 139 representative of any such differences or mismatches.

The reference pattern generator 35 may be implemented, for example, by a fixed logic one or logic zero level, or a linear feedback shift-register that provides an expected or reference data pattern 135 based on an incoming data stream. In an alternate embodiment, the reference pattern generator 35 may be implemented by a second bit decision or sampling circuit, having a corresponding second variable delay element, where the second sampling circuit provides a reference signal in the open middle of the data bit time.

The mismatch signal 139 from the comparator 39 is provided as a first input to a first logic circuit, for example, an AND gate 40. The second input of the AND gate 40 is coupled to the output of a second logic circuit, for example, OR gate 41. The output of the AND gate 241 represents the mis-matches detected by the comparator 39 within the entire length of the sampled input data stream 132 as compared to the expected or reference data stream 135, or any mismatches in a particular one or more bits within the input data signal as controlled by a bit decision output signal 141. (Reference data stream, generically, means a pre-determined expected-value (e.g. a copy of the input data stream) or a fixed value of all zeros or all ones that can be used for comparison to the data stream unit test.)

The OR gate 41 provides the bit decision output signal 141 which indicates whether a particular bit of interest within the sampled input signal 132, as provided in the mis-matched data signal 139, should be counted or whether the entire mismatched signal 139 should be counted. The determination of whether the entire mismatched stream should be counted or whether a particular bit or bit transition within the sampled data stream 132 should be counted is determined a bit selector circuit 38.

The first input of the OR gate 41 is coupled to the output 141 of the bit selector circuit 38. The second input of the OR gate 41 is coupled to a control signal 150 which indicates whether all of the mismatched bits 139 of the sampled data stream 132 are to be counted or whether a particular bit or series of bits are only to be counted. The control signal 150 may be provided by a controller 36 or be maintained in a register or other suitable hardware device (not shown). All bits (or mismatches) are counted when the value of the control signal 150 is a logic one or high. In this situation, the error counter 37 increments each time a mismatch 139 is detected by the comparator 39 and the comparison counter 47 increments each time a comparison is made (independent of if there was a mismatch found or not). When the value of the control signal is logic zero or low, only the particular one or more bits of interest, as indicated in the bit decision output signal 141 will be counted by the error counter 37 and, again, the comparison counter 47 will increment each time a comparison is then attempted independent of if a mismatch was found or not.

The error counter 37 and comparison counter 47 may be implemented as any suitable device capable of being incremented during a transition of the signal coupled to their respective increment input. The transition may be during the rising or falling edge of the signal present at their respective increment input. The values contained within these counters are used to determine the sub-components of total jitter that are present in the input data signal 31. For example, the value present in the error counter 37 divided by the value present in the comparison counter 47 represents the bit error rate of the sampled data stream.

A controller 36 may be implemented as one or more processors capable of performing the sub-jitter components calculations and the total jitter calculation according to the present invention. Each of the processors within the controller 36 may include an arithmetic logic unit (ALU) for performing computations, one or more registers for temporary storage of data and instructions, and a controller for providing a series of control signals and corresponding values that help configure and control the operations of the bit selector circuit 38. In one embodiment, the controller 36 includes any one of the x86, Pentium™ and Pentium Pro™ and other suitable microprocessors manufactured by Intel corporation, or the 680×0 processor marketed by Motorola or the Power PC™ or other suitable processor marketed by International Business Machines. The controller 36 is not limited to microprocessors, but may take on other forms such as microcontrollers, digital signal processors (DSP), dedicated hardware (e.g. ASIC), state machines or software executing on one or more processors distributed along a network.

As illustrated, the controller 36 provides the control signal 150 to the OR gate 41 which determines whether all mismatches 139 between the sampled input data stream 132 and the referenced data stream 135 are counted or whether a particular bit within the mis-matched data stream 139 are to be counted and used in jitter determination calculations. The controller 36 also provides the divisor value 304 and offset value 305 used by the bit selector to determine which bits of interest are to be used in determining the sub-components of total jitter present in the input data stream 31.

The bit selector 38 may be implemented as an integrated circuit or software executing on one or more processors distributed across a network. The bit selector 38 includes a divisor register 304 which may be used to maintain the divisor value provided by the controller 36. Alternatively, block 304 may be representative of the divisor signal itself. An offset register 305 may be used to maintain the offset value provided by the controller 36. Alternatively, block 305 may be representative of the offset signal itself. The bit selector 38 also includes a phase counter 301, an offset comparator 302, and a divisor comparator 303. The increment input of the phase counter 301 is connected to the sample clock signal 133. The reset input of the phase counter 301 is connected to the output 306 of the divisor comparator 303. The output of the phase counter 311 is provided to the first input to the offset comparator 302 and the second input to the divisor comparator 303. The second input to the offset comparator 302 is the offset value provided by either an applicable register or storage device or the controller 36. The first input to the divisor comparator 303 is the divisor value provided by either an applicable register or storage device or the controller 36.

The phase counter 301 is configured to count the signal transitions (or clock edges) present within the sample clock signal 133. As the count increments, the count value 311 is compared to the divisor 304. When the two values are equal, the divisor comparator output 306 causes the phase counter 301 to reset back to zero or some other predetermined value and start a new counting sequence. While this count is progressing, each phase count value 311 is also being compared to the offset value 305 at offset comparator 302. When the phase count value 311 and the offset value 305 are equal, the bit selection control signal 140 is generated which indicates that the particular bit within the sample is of interest and should be compared to the reference data stream. This is accomplished by the bit selection control signal 140 incrementing the comparison counter 47 as well as sending the particular bit of interest value to be sent to the AND gate 40. The offset and divisor values may change to various values throughout the bit window of the input data stream and at any time based on the information provided by the controller 36.

Error counting depends both on having a bit of interest, as indicated by bit selection control signal 141 and a mismatch between the sampled input data stream 132 and the reference data stream 135 as provided by the output 139 of comparator 39. When both a mis-match and a bit of interest are present, the error counter 37 will be incremented. If either situation is not present, the error counter 37 will not be incremented; signifying that the particular bit of interest or waveform will not be used to determine the jitter within the communications channel.

FIG. 3 is a flow chart illustrating the steps performed by the separation circuit when determining the total jitter present within a communications channel. The method 200 begins at step 202 and continues through step 215. In step 202, the input data stream is sampled. This may be accomplished, by the sampling circuit providing the sampled version of the input data stream in response to the sampling control signal. This sampling may be done at isolated or individual points within the input data stream, or may encompass the entire data stream depending on the value of the sampling control signal.

In step 204, the amount of data dependent jitter present within the input data stream is determined. This is calculated by subtracting the earliest transition from the latest transition of the sampled input data stream. This may be accomplished, for example, by sampling each bit within the sampled input data stream and for each bit, determining the average transition time by varying the decision time about the transition time and measuring the bit error rate provided by the mismatch comparator (as maintained in the error counter). This may be accomplished, for example, sampling the input data stream using a fixed threshold for all bits in the data stream. Once completed, perform a second sampling pass with varying threshold values for all bits in the data stream.

In data dependent jitter, all bits within the data stream that have transitions on them are of interest; thus, the bit selector provides the bit selection control signal for each bit within the data stream one at a time. Bit error rate measuring of the comparator results can be used to determine the mean transition time as the rate of mis-match between the reference data pattern and the sampled input data pattern at a given decision time. The point along the sampled data stream where one-half of the bits are correct, and the other half are incorrect corresponds to a bit error rate of one-half. This point represents the mean transition time or the data dependent jitter value of the input data stream. Other methods may also be employed to identify the mean transition time using the mis-match counter results.

Emphasis jitter is a sub-component of data dependent jitter and is measured in this step, for example, by repeating the aforementioned mean transition time determination for each transition bit within the sampled data pattern while adjusting the logic threshold for each bit. The logic threshold is moved up or down by an amount ΔV, which depends on the amount of voltage emphasis present on the signal, whether the particular bit of interest is a low-to-high transition point or a high-to-low transition point and if the previous bit has also been a transition or not.

In step 206, the amount of inter-symbol interference jitter present within the input data stream is determined. This is calculated by separately determining the peak-to-peak difference between the average transition times for low-to-high transitions and for high-to-low transitions. The larger of the aforementioned values represents the inter-symbol interference jitter measurement.

In step 208, the amount of random and periodic jitter present within the input data stream is determined. This is calculated by sampling any single data bit within the sampled data stream, varying the decision time before and after an applicable transition and measuring the bit error rate in order to determine the random jitter. This may be accomplished, for example, by choosing a single bit in the sampled data stream and performing a series of bit error rate measurements about the selected bit and then compute the Dual-Dirac random jitter/dependent jitter separation from the bit error rate values provided by the mis-match comparator. The Dual-Dirac computation is known to those of ordinary skill in the art and will not be described in great detail here so as to not overburden and complicate the description of the present invention. The non-random component of jitter measured on a single bit of the pattern using the Dual-Dirac method is the periodic jitter present within the signal.

In step 210, the amount of sub-rate jitter present within the input data stream is determined. This may be accomplished, for example, by stepping through all sub-rates (or frequency portions) of interest, by varying the value of the divisor within the bit selector and computing the peak-to-peak deviation of average transition times for all points along the sampled data stream indicated by the bit selection control signal. Because some sub-frequencies are octaves of other sub-frequencies, it is important not to double count jitter from harmonically related octaves. For example, if the applicable divisor value is twelve, any sub-frequency jitter calculated for divisors 2, 3, 4 and 6 are also included within the measurement and must not be double counted.

In step 212, the amount of asynchronous jitter present in the input data stream is determined. This may be accomplished, for example, by subtracting the amount sub-rate jitter determined in step 210 from the amount of periodic jitter determined in step 208. At this point, each of the components that combines for form the total jitter present within a communications channel has been separated and determined by the present invention.

In step 214, the total amount of jitter present in the input data stream is determined. This may be accomplished, for example, by adding the jitter sub-component values determined in steps 204 through 212. This operation may be performed by the controller that forms a component of the separation and measurement circuit of the present invention. Alternatively, this operation may be performed by a device remote from the separation circuit.

In step 215 a determination is made as to whether the sampling is complete. This may be accomplished, for example, when there is no signal present at the output of the sampling circuit. When no signal is present at the output, the process ends. Otherwise, the process proceeds to step 202 where the signal present at the input of the sampling circuit is transmitted to the output in response to a applicable signal transition of the sampling control signal present at the clock input of the sampling circuit.

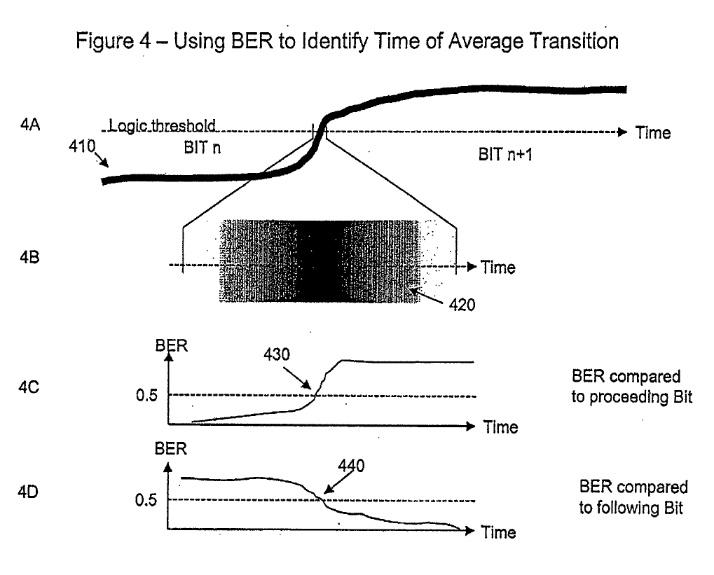

FIGS. 4A-4D are diagrams illustrating how bit error rate measurements may be used to identify average bit transition time in the presence of jitter. FIG. 4A illustrates a typical jittery data bit edge 410 in a data stream. This exemplary edge represents a zero-to-one transition. Any edge or group of edges can also have their average bit transition measured using the method of the present invention. FIG. 4B is an exploded view of the distribution of several bit edges crossing the logic threshold of the transition point of interest. As shown, each repeating bit transition 420 varies in time by small amounts and that this may form a distribution of bit transition times for this particular transition point or bit edge.

In order to determine the average bit transition time, the bit error rate of the data edge is measured at time instants about a transition point 431. FIG. 4C shows that the bit error rate 430 may vary from zero (no errors) to one (all errors) from before and after the bit transition point 431. One of several search techniques may be used, for example, a binary search to efficiently find the precise point in time where the bit error rate is one-half. This point indicates that just as many bit transitions were before the time of the transition point 431 as after the transition point 431. This time corresponds to the average transition time.

FIG. 4D shows that the bit error rate (BER) measurement may be made with respect to either the proceeding or following bit and that both directions are adequate for such measurements. As shown, the measured bit error rate 440 varies from one (all errors) to zero (no errors) and a similar search mechanism to that described above with respect to FIG. 4C can be employed to determine the one-half bit error rate point.

While the foregoing detailed description has described several embodiments of method for separating jitter, It will be appreciated by those skilled in the art that methods of separating jitter are also possible within the spirit and scope of the instant invention and thus, it is to be understood that the above description is illustrative only and not limiting of the disclosed invention. It will be appreciated there are also various modifications to the method suitable for use in the exemplary embodiments discussed above and that there are numerous embodiments that are not mentioned but within the scope and spirit of this invention. Thus, the invention is to be limited only by the claims as set forth below.

What is claimed is:

1. A measurement circuit, comprising:
a sampling circuit operative to provide a sampled version of an input data stream in response to a sampling control signal;
a comparison circuit operative to provide a signal representing the difference between the sampled input data and a reference pattern;
an error counter circuit operative to maintain the number of times the sampled input data does not match the reference pattern or a bit selection value within a bit window; and
a bit selector circuit operative to provide the bit selection value in response to the bit sampling window of the circuit.

2. The measurement circuit of claim 1, further including a controller operative to provide a divisor value and an offset value to the bit selector circuit, which controls whether the bit selection value is provided by the bit selector circuit.

3. The measurement circuit of claim 1, further including a logic circuit operative to determine whether all data mismatches are counted or whether mismatches of a predetermined bit within the bit window are counted.

4. The measurement circuit of claim 1, further including a clock signal generator operative to provide the sampling clock signal.

5. The measurement circuit of claim 4, further including a variable delay circuit operative to vary the application of the sampling clock signal to the sampling circuit.

6. The measurement circuit of claim 1, further including a reference pattern generator operative to provide the reference pattern to the comparison circuit.

7. The measurement circuit of claim 6, wherein the reference pattern generator further includes a linear feedback shift-register operative to generate the reference pattern in response to the sampled data stream, where the generated reference pattern is synchronized to the input data stream.

8. The measurement circuit of claim 6, wherein the reference pattern generator further includes a comparator placed in an error-free portion of the bit window.

9. The measurement circuit of claim 2, wherein the controller further includes circuitry operative to determine the several components of total jitter that are present within the input data stream in response to the information maintained the error counter and a comparison counter.

10. The measurement circuit of claim 1, wherein the comparison circuit is operative to separate random jitter from periodic jitter within the sampled input data.

11. A jitter measurement and separation method, comprising:
sampling an input data stream;
comparing the input data stream to a reference data stream at predetermined programmable time intervals;
determining the amount of random jitter present within the input data stream; and
determining the amount of deterministic jitter present within the input data stream, which comprises the steps of determining the amount data dependent jitter present within the input data stream and determining the amount of periodic jitter present within the input data stream.

12. The jitter measurement and separation method of claim 11, wherein determining the amount of data dependent jitter present within the input data stream further includes determining the amount of inter-symbol interference within the input data stream.

13. The jitter measurement and separation method of claim 12, wherein determining the amount of data dependent jitter present within the input data stream further includes determining the amount of duty cycle distortion present within the input data stream.

14. The measurement circuit of claim 6, wherein the reference pattern generator can be fixed logic levels of 1, 0 or any user-defined pattern stored in a memory.

15. The jitter measurement and separation method of claim 12, wherein determining the amount of data dependent jitter present within the input data stream further includes determining the amount of emphasis jitter present within the input data stream.
